(19) United States
(12) Patent Application Publication
(10) Pub. No.: US 2006/0099362 A1
(43) Pub. Date: May 11, 2006

(54) Enhanced barrier packaging for oxygen sensitive foods

(75) Inventor: Said Farha, Pleasantville, NY (US)

Correspondence Address: RYNDAK & SURI LLP, 200 W MADISON STREET, SUITE 2100, CHICAGO, IL, 60602, US

(73) Assignee: PepsiCo, Inc.

(21) Appl. No.: 10/981,842

(22) Filed: Nov. 5, 2004

(51) Int. Cl. B32B 27/32

(52) U.S. Cl. 428/35.2

(57) ABSTRACT

An oxygen-scavenging composition for use with oxygen-sensitive materials is a blend of an acidified PET, an oxidizable component, and a transition metal. The oxygen-scavenging compositions are made by providing an acidified PET, and blending the acidified PET with an oxidizable component and at least one of a transition metal and a transition metal compound.

### BACKGROUND OF THE INVENTION

1. Field of the Invention

The present invention is generally directed to containers and preforms for such containers and to methods of producing such preforms and containers. In particular, the present invention is directed to gas-scavenging compositions and to containers and preforms having at least one layer comprising a gas-scavenging composition.

2. Discussion of the Related Art

The use of plastics has replaced glass and metal in many applications for reasons including moldability, light weight, strength, and cost. However, plastics approved for contact with food by the FDA, such as PET, have a significant gas permeability when compared to that of glass and metal containers. As a result, unless a gas barrier is provided, atmospheric oxygen permeates into such containers, and carbon dioxide in carbonated beverages permeates out. This reduces the shelf life of foods and beverages sold in such containers, particularly where the product is carbonated and/or sensitive to degradation by oxygen. Various specialty polymers and layered structures have been developed in attempts to provide a commercially-acceptable shelf life for carbonated beverages and some oxygen-sensitive products, such as fruit juice and ketchup.

For example, U.S. Pat. No. 5,472,753 to Farha discloses three-ply preforms and other laminates, having a first layer of a phenoxy-type thermoplastic, a second layer of an amorphous thermoplastic copolyester, and a third layer of PET, and two-ply preforms and other laminates, having a first layer and a second layer. The first layer comprises a phenoxy-type thermoplastic and an amorphous thermoplastic copolyester, and the second layer comprises PET. The disclosed phenoxy-type thermoplastics are polyhydroxy ethers), poly(hydroxy ester ethers), and poly(hydroxy amino ethers) having a high degree of polymerization. Poly(hydroxy amino ethers) are disclosed as being particularly preferred.

To improve the shelf life of oxygen sensitive products, both passive and active oxygen-barrier materials have been developed, which may be used alone or in combination. Passive barrier materials, such as those disclosed in the Farha patent physically block at least a portion of the gas permeation through the wall of a container. Generally, a container comprising a passive oxygen barrier has a multilayer wall structure in which at least the layer contacting the beverage or food product is an FDA approved structural material, such as polyethylene terephthalate (“PET”). The wall of the container generally has at least one barrier layer comprising a polymeric oxygen barrier material, such as polyvinylidine chloride copolymer (“PVDC”) or ethylene vinyl alcohol (“EVOH”). Preferably, the container further comprises an outer layer of a polymeric structural material, which may be recycled, such as post consumer or recycled PET (“RPET”).

In contrast, an active barrier material acts as an oxygen scavenger, chemically or physically trapping oxygen within a layer of the container wall. As a result, in addition to blocking oxygen from permeating into a container, it is theoretically possible to remove oxygen trapped within the container when the container is filled. Containers comprising active oxygen barriers may comprise a plurality of layers, where one or more layers in the wall of the containers comprises at least oxygen scavenger, such as an oxidizable compound, or the container may comprise a monolayer blend that contains an oxygen scavenger. For example, a monolayer container may comprise a blend of PET, PEN, and MXD-6. If the barrier layer is sufficient to stop permeation into the container, oxygen within the container will permeate into the wall, where it is scavenged by the active barrier. As no oxygen can enter such a container, the oxygen concentration within the container will theoretically decrease over the shelf life of the product. However, as prior art oxygen scavengers are not 100 percent efficient, there is a finite contribution to the oxygen content of the package by the permeation of oxygen, and, as a result, the oxygen concentration in such containers increases over the shelf life of the product.

U.S. patent application Ser. No. 10/850,573 to Schmidt (“the Schmidt application”), the parent of which was published as U.S. patent application Publication No. 2002/0022099, discusses a commercial hot-fill juice container that provides an oxygen barrier improvement of a factor of 1.5 to 4 over standard single layer PET. The five layer juice containers discussed by Schmidt comprise a central core layer and inner and outer layers that consist of virgin PET, sandwiched around two intermediate layers of EVOH. However, the shelf life for non-refrigerated beer in such containers is still only 7 to 14 days due to continued permeation of oxygen into the containers.

As discussed in the Schmidt application, polyethylene naphthalate (“PEN”) has an oxygen permeability that is a factor of 5 less than that of PET, and a significantly higher glass transition temperature, T_{g}, i.e., about 120° C. compared to 80° C. for PET. Such a high T_{g} is desirable for temperature resistant containers in which the contents are pasteurized. However, PEN is significantly more expensive than PET, and does not scavenge residual oxygen from within the container.

Blends of PEN and PET have been suggested, but the small improvement in the gas barrier properties and the high cost of PEN make this an unattractive option. Blends of polyamides, such as MXD-6, and PET suffer from a lack of transparency. However, certain organic polymers, including polyamides, such as MXD-6, have been found to act as oxygen-scavengers when activated by at least one transition metal. That is, in the presence of a transition metal, the polymer is oxidized by permeating oxygen, preventing oxygen permeation into the container.

However, as noted above, blends of PET and polyamides and other metal-activated oxidizable organic polymers are often cloudy or opaque when a significant amount of the oxidizable polymer is present in the blend. The PET and oxidizable polymer are incompatible, and, thus, the resulting blends lack the transparency required by consumers in containers for many foods and beverages.

U.S. Pat. No. 5,034,252 to Nilsson et al. discloses an oxygen-scavenging mixture of PET, a polyamide, and an activating metal having an oxygen permeability that is reportedly a factor of 100 less than that of PET alone. However, when a polyamide is mixed with PET in an amount of at least about 10 percent by weight, due to the incompatibility of the polymers, the resulting mixture is brittle, interfering with molding a preform into a container, and reducing the mechanical strength of the final container. In addition, the disclosed polymer blends are discolored or wholly or partially opaque or “hazed” where the polyamide is present in an amount of at least about 10 percent by weight. Therefore, the disclosed polymer blends are limited to 1 to 7 percent by weight polyamide, and, preferably, 2 to 4 percent by weight. However, it has been found that blends of PET and polyamides are discolored or yellow even when the polyamide is present in low levels, as taught by Nilsson et al., making the resulting containers less than acceptable to consumers for many foods and beverages.

U.S. Pat. No. 5,021,515 to Cochran et al. discloses blends of polyesters and oxidizable polymers in which the oxidation of the oxidizable polymer is catalyzed by a metal. Disclosed polyesters include PET; disclosed oxidizable polymers include amides, polyamides, such as MXD-6, and phenols, such as 2,4,6-tri-(t-butyl)phenol; and the disclosed metals are transition metals. For multilayer structures, co-extrusion and lamination using adhesive tie layers are disclosed. There is no disclosure regarding the transparency of the blends.

Therefore, a need exists for compatible blends of PET and an active oxygen barrier material. The present invention provides such a blend.

### SUMMARY OF THE INVENTION

The present invention is directed to novel oxygen-scavenging compositions that overcome the deficiencies of the prior art, to methods of making such compositions, to articles made from the compositions of the invention for use with oxygen-sensitive materials, and to methods of making such articles. Compositions in accordance with the invention comprise a blend of an acidified PET, an oxidizable component, and a transition metal catalyst. Preferably, the transition metal catalyst comprises at least one of an ion, compound, or complex of a transition metal selected from the group consisting of cobalt, rhodium, and copper, such as a carboxylate of cobalt, a carboxylate, such as a neodecanoate, octoate, or acetate, of copper, and a carboxylate of rhodium. More preferably, the transition metal catalyst is at least one of cobalt neodecanoate, cobalt octoate, and cobalt acetate.

Preferably, the oxidizable component is a polymer, such as a polyamide. More preferably, the oxidizable component is a nylon, and, most preferably, MXD-6. The acidified PET may comprise at least one of a sulfonated PET and an anhydride grafted PET, wherein acid groups in the sulfonated PET and anhydride grafted PET are substantially free of neutralization by metal ions prior to blending with the transition metal catalyst, or at least one of an alkali metal, an alkaline earth metal, and a transition metal ionomer of RPET.

The method of making an oxygen-scavenging composition of the invention comprises the steps of obtaining an acidified PET, and blending the acidified PET with an oxidizable component and at least one transition metal catalyst in one or more blending steps. The acidified PET may be obtained by either sulfonating PET or grafting an organic acid or anhydride to PET to form a non-neutralized acidified PET having a plurality of acid groups. The acidified PET may also be a PET ionomer, obtained by neutralizing acid groups on the acidified PET with a metal oxide or hydroxide. The blending step may comprise coextruding the acidified PET, the oxidizable component and the transition metal. Preferably, the method of the invention comprises obtaining an oxygen-scavenging composition in accordance with the invention, and molding at least one layer of an article comprising the oxygen-scavenging composition, which may be blended with at least one thermoplastic polyester.

Preferably, the method of the invention further comprises at least one of blending a PET ionomer with a polyamide, drying the resulting blend, and blending the dried blend with a thermoplastic polyester and the transition metal catalyst; blending PET with para-toluene sulfonic acid to form a sulfonated PET, drying the sulfonated PET, blending the dried sulfonated PET with a polyamide, drying the resulting blend, and blending the dried blend with a thermoplastic polyester and the transition metal catalyst; and grafting an anhydride to PET, blending the anhydride grafted PET with a polyamide, drying the resulting blend, and blending the dried blend with a thermoplastic polyester and the transition metal catalyst.

### BRIEF DESCRIPTION OF THE DRAWINGS

FIG. 1 illustrates a preform of the invention;

FIG. 2 illustrates a cross-section of the preform of FIG. 1;

FIG. 3 illustrates a cross-section of a multilayer preform of the invention;

FIG. 4 illustrates a cross-section of a multilayer preform of the invention in which the outer layer extends to the finish;

FIG. 5 illustrates an inject-over-inject molding apparatus; and

FIG. 6 illustrates a lamellar injection molding apparatus.

### DETAILED DESCRIPTION

As used herein, the term “acidified PET” refers to any of a polyethylene terephthalate (“PET”) ionomer, a sulfonated PET, and an anhydride grafted PET, as defined below.

As used herein, the term “PET ionomer” refers to a PET having pendant acid groups on the polymer chain, i.e., an acidified PET, where at least a portion of the acid groups are neutralized with metal ions. The pendant groups may be added to the PET polymer chain by sulfonation or by grafting with an organic acid by any method known in the art. Preferably, the metal ions are alkali metal, alkaline earth metal, or transition metal atoms. More preferably, the acid groups are neutralized by blending the acidified PET with a metal oxide or hydroxide, and removing the water produced in the neutralization reaction.

As used herein, the term “sulfonated PET” refers to PET that has been mixed with a sulfonating agent for a time sufficient to form acidic pendant sulfate groups on the polymer chain. A sulfonated PET is preferably formed by blending PET with para-toluene sulfonic acid (“PTSA”), and drying the resulting blend before blending with other components of the compositions of the invention. For the purposes of this disclosure, the sulfate pendant groups on a sulfonated PET are not neutralized to any appreciable extent prior to blending the polymer with a transition metal or transition metal ion, compound, or complex.

As used herein, the term “anhydride grafted PET” refers to a PET having anhydride pendant groups grafted to the polymer chain. The anhydride pendant groups may be grafted to the PET by any method known in the art. As with a sulfonated PET, anhydride pendant groups on a anhydride grafted PET are not neutralized to any appreciable extent prior to blending with a transition metal or a transition metal ion, compound, or complex for the purposes of this disclosure.

As used herein, the terms “oxygen scavenger” and “oxidizable component” refer to a chemical species, such as a compound or composition, in which at least a portion of the chemical species reacts with or traps oxygen. As the oxygen scavenger or oxidizable component reacts with oxygen, it will be recognized that the oxidizable component is degraded over time. Preferably, the oxidation is activated or catalyzed by at least one transition metal or transition metal ion, compound, or complex that acts as an activator or catalyst.

As used herein, the terms “activation” and “initiation” refer to the action of a component of a composition, i.e., an activator or initiator, that initiates or makes possible a chemical reaction without taking any other part in the reaction. That is, with the exception of any possible side reaction, the activator or initiator is involved in the desired reaction only to the extent necessary to initiate the reaction, such as by producing free radicals.

As used herein, the term “catalyst” refers to a component of a composition that takes part in the reaction, but is returned to its original state upon completion of the reaction, such that it is available for further reaction. The catalyst may be heterogeneous, providing a surface that allows the reaction to proceed at a lower energy, or the catalyst may be a homogeneous catalyst, which forms an intermediate or transition state with the reactants, facilitating the reaction, but is returned to its initial state in the reaction. As will be recognized by those skilled in the art, a catalyst may be consumed by parallel or side reactions that occur with the desired reaction.

The present invention is directed to oxygen-scavenging compositions, articles, particularly containers and preforms for such containers, made from the compositions of the invention, and to methods of making such compositions, articles, containers, and preforms. Articles in accordance with the invention comprise at least one layer of a composition in accordance with the invention, i.e., a blend of an acidified PET, an oxidizable component, and a transition metal catalyst.

The transition metal is preferably rhodium, copper, or cobalt, where cobalt is most preferred. Also, the transition metal preferably has a positive oxidation state, and is preferably added to the blend in the form of a compound, such as a salt or a complex or coordination compound. Preferably, for use as a catalyst in the present invention, cobalt has an oxidation state of +2 or +3, i.e., cobalt II or III, rhodium has an oxidation state of +3, i.e., rhodium III, and copper has an oxidation state of +2, i.e., copper II. Useful compounds include, but are not limited to, carboxylates of rhodium, copper, and cobalt, such as rhodium, copper, and cobalt neodecanoate, octoate, and acetate.

The oxidizable component is preferably an oxidizable polymer, such as a polyamide. More preferably, the oxidizable component is a nylon, where MXD-6 is most preferred. Other useful oxidizable components include, but are not limited to, polymers containing dienic and olefinic unsaturations as part of the main polymer chain or pendant groups on the polymer chain.

The acidified PET preferably comprises one of a PET ionomer, a sulfonated PET, and an anhydride grafted PET. PET ionomers are PET polymers having one or more acidic groups on the PET polymer chain, where at least a portion of the acid groups are neutralized with one or more metal ions, such as alkali, alkaline earth, and transition metal ions. The neutralization process may be performed by blending PET, acidified with an appropriate acidic group with any appropriate method known in the art, with a metal oxide or hydroxide, and drying the resulting ionomer to remove the water produced in the neutralization reaction. Preferably, the metal is sodium or a transition metal, such as rhodium, copper, or cobalt, where the transition metal may function as a catalyst for the oxidation of the oxidizable component.

Sulfonated PET may be obtained by blending PET with an amount of PTSA sufficient to sulfonate the PET to the desired degree, i.e., about 0.5 to about 2 mole percent, and drying the resulting sulfonated PET. Anhydride grafted PET may be obtained by grafting an anhydride, such as maleic anhydride, to the PET polymer chain by any appropriate method known in the art. Useful anhydride grafted PET polymers include those grafted with maleic anhydride and pyromellitic dianhydride. As discussed above, at least a portion of the acid groups on a sulfonated PET may be neutralized with metal ions to form a PET ionomer. However, the anhydride groups of an anhydride grafted PET are not neutralized for use in the invention.

Oxygen-scavenging blends in accordance with the invention preferably comprise an acidified PET and an oxidizable component in a weight ratio of acidified PET to oxidizable component of from about 0.1 to 10 to about 10 to 1, and an amount of transition metal catalyst of from about 50 parts per million (ppm) to about 600 ppm, based on the combined weight of the acidified PET and oxidizable component, and without regard to any other material in the composition. Therefore, when blended with a non-acidified thermoplastic polyester, the amounts of the acidified PET, oxidizable component, and transition metal catalyst relative to the total weight of the composition will decrease with increasing amounts of the non-acidified thermoplastic. However, the weight ratio of acidified PET to oxidizable component, and the amount of transition metal catalyst relative to the combined weight of acidified PET and oxidizable component will preferably be as described above. For example, for a final composition comprising a non-acidified thermoplastic polyester and up top 20 percent by weight of the oxygen-scavenging blend, described above, the composition will comprise an acidified PET in an amount of from about 0.1 to about 10 percent by weight, an oxidizable component in an amount of from about 1 to about 10 percent by weight, and a transition metal catalyst in an amount of from about 50 to about 600 ppm. In such a blend, the weight ratio of acidified PET to oxidizable component is from about 0.1 to 10 to about 10 to 1, and the amount of transition metal catalyst is from about 50 ppm to about 600 ppm, based on the combined weight of the acidified PET and oxidizable component only. As will be understood by those of ordinary skill in the art, amounts relative to the total composition will increase or decrease proportionally as the amount of non-acidified thermoplastic ionomer in the final composition is decreased or increased, respectively. Preferably, the acidified PET is present in an amount of from about 1 to about 3 percent by weight, the oxidizable component is present in an amount of from about 2 to about 4 percent by weight, the transition metal is present in an amount of from about 300 to about 500 ppm, and the non-acidified virgin PET is present in an amount of from about 93 to about 97 percent by weight.

A particularly preferred oxygen-scavenging composition comprises an acidified PET in an amount of about 2 percent by weight, an oxidizable component of MXD-6 in an amount of about 3 percent by weight, a catalyst of cobalt neodecanoate in an amount of from about 300 to about 400 ppm, and a non-acidified virgin PET in an amount of from about 95 percent by weight.

Preforms, containers, particularly bottles, and dispenser bags may be formed of a single layer of the oxygen-scavenger of the invention. However, in certain applications it may be desirable to use the oxygen-scavenging layer of the invention in a laminated structure. It has been found that oxygen-scavenging blends of the invention adhere better to a layer of PET than do layers of polyamide and noncompatibilized blends of PET and a polyamide. Therefore, delamination that results in a high level of haze in blown containers is substantially reduced or eliminated with the blends of the invention.

In addition, blends of PET and polyamides, such as MXD-6, have a yellow color that is unacceptable in packaging applications that require a substantially uncolored container. It has been found that the blue color of the preferred cobalt catalysts counteracts the yellow tint of the blends of acidified PET and MXD-6, providing a blend that is substantially colorless or neutral colored.

The compatibility of the oxygen-scavenging blends of the invention greatly reduces the potential for the migration of products of oxygen-scavenging into the container, reducing or eliminating organoleptic and safety concerns. The enhanced adhesion of the blends of the invention to PET also allows the use of multilayer structures in which delamination and migration are substantially reduced or eliminated, further reducing concerns regarding the migration of oxygen-scavenging products into the container. Using an inner layer of virgin PET for contact with any beverage or food product also allows the use of post consumer or recycled PET (“RPET”) in the blends of the invention.

Such multilayer structures may be formed using co-injection techniques known in the art or the inject-over-inject (“IOI”) techniques disclosed in U.S. Pat. No. 6,391,408 to Hutchinson, the contents of which are incorporated herein by reference to the extent necessary to describe IOI techniques and useful materials, as well as the LIM techniques described below. Inject-over-inject is a procedure using injection molding to inject one or more layers of thermoplastic material over an existing injection-molded preform. Inject-over-inject may also be referred to as “overinjecting” and “overmolding.” Preferably the outer layer or layers are overmolded while the inner layer is not yet fully solidified to facilitate bonding between the layers. As will be understood by those skilled in the art, the material used to form each layer molded onto a preform preferably has a glass transition temperature, T_{g}, that is similar to that of the material used to form the preform, such that the layered preform does not crack, haze, or delaminate during blow molding.

A variation of inject-over-inject uses lamellar injection molding (“LIM”) in which the melt stream comprises multiple thin layers of different materials. As disclosed in the Hutchinson '408 patent, LIM may be used in inject-over-inject as LIM-over-inject or inject-over-LIM. When desired, LIM-over-LIM may also be used.

While the blends of the invention are active oxygen-scavengers, they only act as passive barriers to carbon dioxide. Therefore, for containers for carbonated beverages, such as soda or beer, an additional layer of a carbon dioxide barrier material may be applied to the container or the preform used to mold the container.

Preferably, the barrier layer is a phenoxy-type compound or poly(hydroxyamino ether) (“PHAE”) of the type used in the layered preforms disclosed in the Farha '753 patent and U.S. patent application Ser. No. 10/090,471 to Hutchinson, and published as U.S. patent application No. 2003/0012904. Coatings may be applied using IOI techniques or by the dip, spray, and/or flow techniques disclosed by the Hutchinson application, the teachings of which are incorporated herein to the extent necessary to describe the coating techniques and phenoxy-type and PHAE materials.

The oxygen scavenging rate of the compositions of the invention can be increased by blending in an ultraviolet (“UV”) barrier material, such as polyethylene naphthalate (“PEN”).

The use of a passive barrier layer between the oxygen-scavenging layer and the atmosphere also prolongs the activity of the active layer, as it reduces the amount of oxygen reaching the scavenger at any given time.

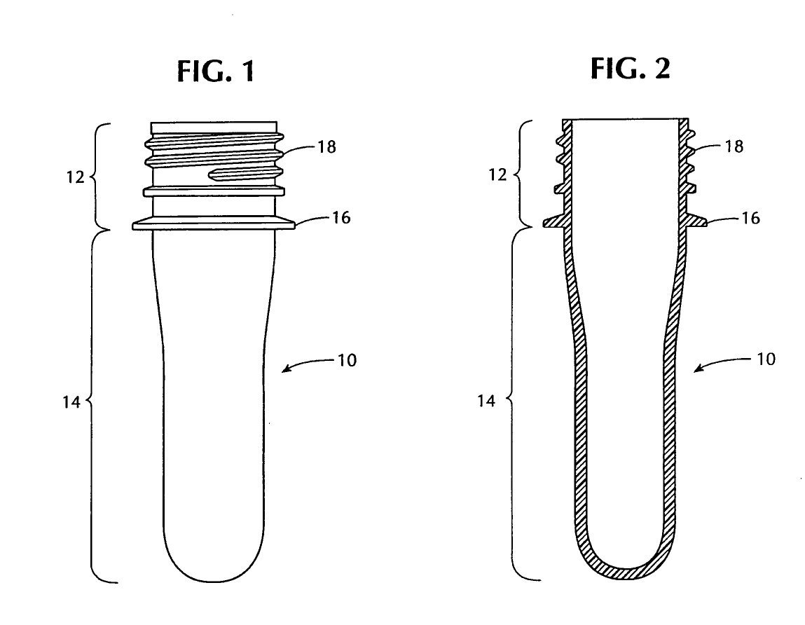

The oxygen-scavenging compositions of the invention may be used to form any type of article in which oxygen-scavenging is desired. The oxygen-scavenging compositions of the invention are particularly useful in bottles, dispenser bags, and other containers, as well as preforms for forming such containers. Preforms made with the oxygen-scavenging compositions of the invention may be molded using any useful molding method known in the art that will provide a seamless thermoplastic preform. Preferably, however, the preform is injection-molded. A preform 10 useful in the invention is illustrated in FIG. 1 and in cross-section in FIG. 2. The preform 10 comprises a finish or neck portion 12, a body portion 14, and a support ring 16, where the finish 12 and body 14 are preferably seamlessly joined. As illustrated, the finish 12 comprises threads 18, which, after blow molding of the body portion 14, may be used to seal the resulting container with a closure. However, configuration of the finish 12 is not limited to threads 18. Instead, any useful configuration that will allow sealing with a closure may be used.

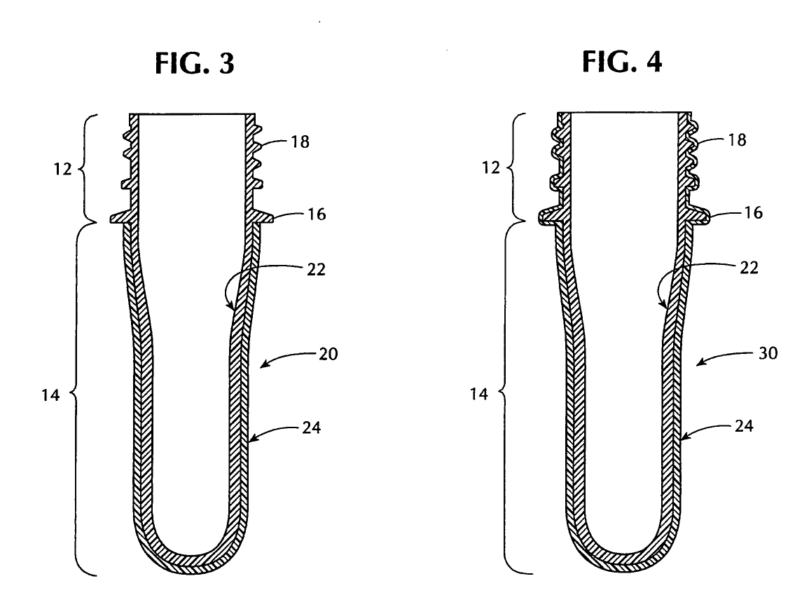

A cross-section of a multilayer preform 20 useful in the invention is illustrated in FIG. 3. As with the preform 10 illustrated in FIGS. 1 and 2, the multilayer preform 20 comprises a seamlessly joined finish 12, a body portion 14, and a support ring 16. The body portion 14 comprises an inner layer 22, seamlessly joined to, and, preferably, molded in a single piece with the finish 12, and at least one outer layer 24. Preferably, the outer layer 24 is formed from an oxygen-scavenging composition of the invention, and the inner layer 22 is formed from virgin PET.

A cross-section of a further embodiment of a multilayer preform 30 useful in the invention is illustrated in FIG. 4. As with the preforms 10 and 20 illustrated in FIGS. 1, 2, and 3, the multilayer preform 30 comprises a seamlessly joined finish 12, a body portion 14 and a support ring 16. The body portion 14 comprises an inner layer 22, seamlessly joined to, and preferably, molded in a single piece with the finish 12, and at least one outer layer 24. Preferably, the outer layer 24 is formed from an oxygen-scavenging composition of the invention, and the inner layer 22 is formed from virgin PET. In contrast to the preform 20, the outer layer 24 of the preform 30 extends to and covers the threads 18 of the neck finish 12. Preferably, any coating that is disposed on or above the support ring 16 is made of an FDA-approved material.

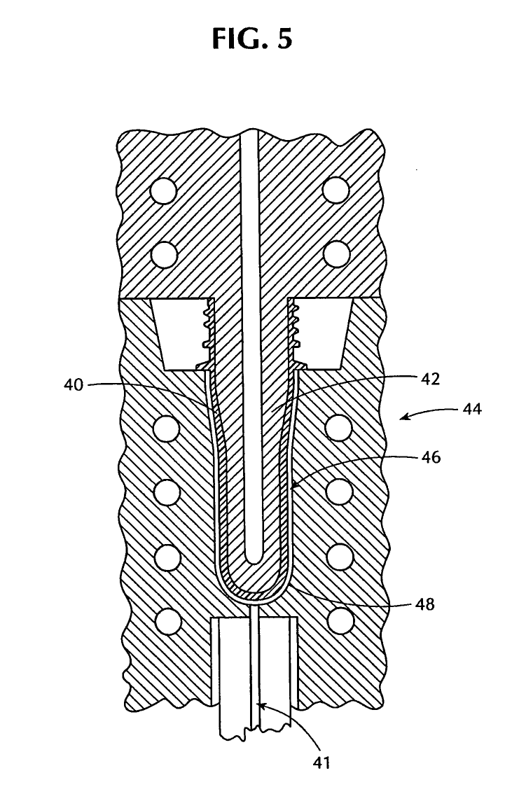

The outer layer 24 of the preforms 20 and 30 may be formed using any useful method known in the art. Preferably, the preform is molded using inject-over-inject, as illustrated in FIG. 5. Using the inject-over-inject process, a preform 40 is injection-molded on a core 42 in a first mold (not shown), where the core 42 and first mold are both preferably cooled. The preform 40 and core 42 are then transferred to a second cooled mold 44. At least one layer of thermoplastic resin is then injection-molded through inlet 41 onto the outer surface 46 of the preform 40 in the gap 48 formed between the outer surface 46 and the second mold 44. After cooling, a multilayer preform of the type illustrated in FIG. 3 is obtained.

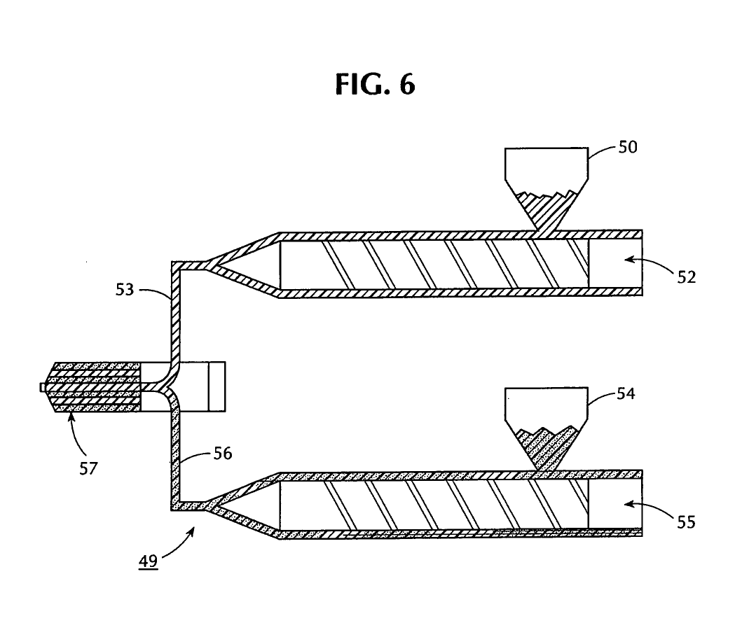

Such multilayer preforms may also be molded using a lamellar injection molding system that is useful for LIM-over-inject, inject-over-LIM, or LIM-over-LIM molding. A lamellar injection molding apparatus 49 is illustrated in FIG. 6. Although the apparatus 49 is suitable for LIM-over-inject, inject-over-LIM molding, and LIM-over-LIM molding, an entire preform may be made using a single LIM molding step. The apparatus 49 comprises a first feed hopper 50, configured to supply a first thermoplastic resin, preferably PET, to a first injection cylinder 52, and a second feed hopper 54, configured to supply a second thermoplastic resin, such as a barrier material, to a second injection cylinder 55. The outputs 53 and 56, respectively, are combined in a layer generator 57 in the desired relative amounts, and used to form at least one portion of a preform (not shown).

Accordingly, it will be appreciated that the present invention has been described with reference to particular preferred embodiments that are now contemplated. However, the invention is not limited by the embodiments disclosed herein, and it will be appreciated that numerous modifications and other embodiments may be devised by those skilled in the art. Therefore, it is intended that the appended claims cover all such modifications and embodiments that fall within the true spirit and scope of the present invention.

1. An oxygen-scavenging composition for use with oxygen-sensitive materials, the composition comprising a blend of an acidified PET, an oxidizable component, and a transition metal catalyst.

2. The composition according to claim 1, wherein the transition metal catalyst further comprises at least one of an ion, compound, or complex of a transition metal selected from the group consisting of cobalt, rhodium, and copper.

3. The composition according to claim 1, wherein the transition metal catalyst further comprises at least one of a carboxylate of cobalt, a carboxylate of copper, and a carboxylate of rhodium.

4. The composition according to claim 1, wherein the transition metal catalyst is selected from the group consisting of cobalt neodecanoate, cobalt octoate, and cobalt acetate.

5. The composition according to claim 1, wherein the oxidizable component is a polymer.

6. The composition according to claim 5, wherein the polymer is polyamide.

7. The composition according to claim 1, wherein the acidified PET and the oxidizable component are present in a weight ratio of acidified PET to oxidizable component of from about 0.1 to 10 to about 10 to 1, and the transition metal catalyst is present in an amount of from about 50 parts per million to about 600 ppm, based on the combined weight of the acidified PET and oxidizable component.

8. The composition according to claim 1, wherein the composition comprises from about 1 to about 3 weight percent of an acidified PET, from about 2 to about 4 percent by weight MXD-6 as the oxidizable component, and from about 300 to about 500 ppm of a cobalt carboxylate.

9. The composition according to claim 1, wherein the acidified PET is at least one of a sulfonated PET and an anhydride grafted PET, wherein acid groups in the sulfonated PET and anhydride grafted PET are substantially free of neutralization by metal ions prior to blending with the transition metal catalyst.

10. The composition according to claim 1, wherein the acidified PET comprises at least one of an alkali metal, an alkaline earth metal, and a transition metal ionomer of RPET.

11. An article comprising at least one layer of the composition according to claim 1.

12. The article according to claim 11, wherein the article is a dispenser bag, container, or a preform for a dispenser bag or container.

13. The article according to claim 11, further comprising at least one barrier layer comprising a carbon dioxide barrier material.

14. The article according to claim 13, wherein the carbon dioxide barrier layer comprises a phenoxy compound or a poly(hydroxyamino ether).

15. An oxygen-scavenging composition, comprising up to about 80 percent by weight of a thermoplastic polyester and at least about 20 percent by weight of the composition according to claim 1.

16. The composition according to claim 15, wherein the thermoplastic polyester comprises PET.

17. The composition according to claim 15, wherein the thermoplastic polyester comprises RPET.

18. A method of making an oxygen-scavenging composition, the method comprising the steps of:
obtaining an acidified PET; and
blending the acidified PET with an oxidizable component and at least one transition metal catalyst in one or more blending steps.

19. The method according to claim 18, the step of obtaining an acidified PET further comprising at least one of sulfonating PET and grafting an organic acid or anhydride to PET to form a non-neutralized acidified PET having a plurality of acid groups.

20. The method according to claim 18, wherein the acidified PET and the oxidizable component are combined in a weight ratio of acidified PET to oxidizable component of from about 0.1 to 10 to about 10 to 1, and the transition metal catalyst is added in an amount of from about 50 ppm to about 600 ppm, based on the combined weight of the acidified PET and oxidizable component.

21. The method according to claim 18, further comprising neutralizing acid groups on the acidified PET with a metal oxide or hydroxide.

22. The method according to claim 18, wherein the blending step further comprises coextruding the acidified PET, the oxidizable component and the transition metal.

23. A method for making an article for protecting oxygen-sensitive material from oxygen, the method comprising;
obtaining an oxygen-scavenging composition in accordance with the method of claim 18; and
molding at least one layer of an article comprising the oxygen-scavenging composition.

24. The method according to claim 23, further comprising blending the oxygen-scavenging composition with at least one thermoplastic polyester.

25. The method according to claim 24, wherein the thermoplastic polyester is PET.

26. The method according to claim 23, further comprising coating the article with a carbon dioxide barrier material.

27. The method according to claim 26, wherein the coating step comprises at least one of dip coating, spray coating, flow coating or injection molding.

28. The method according to claim 26, further comprising at least one of
blending a PET ionomer with a polyamide, drying the resulting blend, and blending the dried blend with a thermoplastic polyester and the transition metal catalyst;
blending PET with para-toluene sulfonic acid to form a sulfonated PET, drying the sulfonated PET, blending the dried sulfonated PET with a polyamide, drying the resulting blend, and blending the dried blend with a thermoplastic polyester and the transition metal catalyst; and
grafting an anhydride to PET, blending the anhydride grafted PET with a polyamide, drying the resulting blend, and blending the dried blend with a thermoplastic polyester and the transition metal catalyst.

29. The method according to claim 28, wherein the PET ionomer is a sodium ionomer of a sulfonated PET, the polyamide is MXD-6, and the thermoplastic polyester comprises at least one of PET and RPET.

30. A container for storing oxygen-sensitive material, having at least one layer, the layer comprising up to about 80 percent by weight of a thermoplastic polyester and at least about 20 percent by weight of the composition according to claim 1.

31. The container according to claim 30, wherein the container is a dispenser bag, bottle, jar, or a preform for making a dispenser bag, bottle, or jar.
